(19) United States
(12) Patent Application Publication
(10) Pub. No.: US 2012/0204724 A1
(43) Pub. Date: Aug. 16, 2012

(54) NBC WEAPON FILTERING DEVICE FOR TREATING LARGE AIR MASS

(75) Inventors: Giancarlo Angelini, Aprilia (LT) (IT); Ornella Ursini, Aprilia (LT) (IT); Paolo Ciccoli, Aprilia (LT) (IT); Marco Adami, Aprilia (LT) (IT); Mario Ravanetti, Aprilia (LT) (IT); Alessandro Pica, Aprilia (LT) (IT); Franco Cataldo, Aprilia (LT) (IT)

(73) Assignee: AERO SEKUR S.p.A., Aprilia (LT) (IT)

(21) Appl. No.: 13/138,965

(22) PCT Filed: Apr. 29, 2010
(86) PCT No.: PCT/IT2010/000192

§ 371 Date: Apr. 25, 2012

(30) Foreign Application Priority Data
May 7, 2009 (IT) RM2009A000224

(51) Int. Cl. B01D 53/04

(52) U.S. Cl. 96/121; 96/152; 96/144

(57) ABSTRACT

The present invention relates to a filtering device for NBC weapons, comprising a hermetically sealed box structure (10), provided with an opening for the inlet of air and/or gas to be filtered and an opening for the outlet of filtered air and/or gas, and within which one or more plates (11) are arranged to define the walls of a course for said air and/or gas from said inlet and said outlet, the sides of the plates (11) facing said course supporting a layer (12) of an adsorbing material.

The present invention concerns a filtering device for NBC weapons for treating big air volumes.

More in particular the invention concerns a device of the said kind, in particular suitable for being used for example on military tanks and ships.

As known, systems currently used for filtering air on military tanks or ships are designed to be able to sustain an anticonventional attack by means of NBC weapons (acronym referring to the Nuclear, Biological and Chemical nature that these weapons can have). Nuclear and biological weapons essentially consist of dusts. In fact, radioactive material is essentially constituted by radionuclides, i.e. by radioactive dusts, and similarly biological weapons are constituted by bacteria, spores or virus being dusts per se or being released in the ambient supported on specific dispersing means generally solids (cfr. Franco Cataldo, Lezioni su Armi Chimiche, Biologiche and Nucleari and Relativa Protezione, Roma, 2004). As a consequence, the exhaustion of said dusts does not pose big problems and is efficacely performer by the present filtration systems that comprise, for example, cyclones and membrane filters arranged before the actual adsorbing bed.

The chemical weapons exhaustion, on the contrary, involves problems connected to the saturation of the adsorbing bed. In fact, such adsorbing bed is, according to the prior art, constituted by activated carbons that necessarily undergo saturation, both in case of continuous operation in a contaminated area and, more often, when operating for prevention purposes in areas not contamined by weapons. In this second case, in fact, the saturation of the adsorbing bed occurs as a consequence of the adsorption of occasional substances such as water (humidity), fuel vapours, solvents, chemical substances and other substances generally present in the air.

The saturation of the adsorbing bed involves the problem of its periodical substitution, and consequently involves a limitation in the autonomy of the military unit, being it a tank or a ship, on which it is applied.

It is also known that, for environmental tests, it is possible to use filtration systems, called “denuder”, operating on the base of the difference of diffusion velocity between air and its gaseous pollutants from one side and dusts on the other side, and thus on the trapping due to inelastic collision of gaseous pollutants on a wall of reactive material. In practice, diffusion tubes or “denuders” used in the field of environmental tests are constituted by two cylindric glass tubes, concentrical, leaving open a circular ring of reduced dimensions (about 1.5 mm). The surface area determined by this circular ring is covered with a substance that can easily chemically interact with the gaseous pollutant contained in the air laminar flow. In fact, gaseous species contained in the carrier gas (air) can rapidly diffond on the walls of the circular ring, where they interact with the covering. On the other side, solid microparticles, due to their lower diffusion coefficient, are not trapped and continue their route in the air laminar flow.

Known “denuder” type systems, however, present a structure that is effective only for air flows in the order of few liters per minute, whereas they are not suitable in cases, as that of interest for the present invention, wherein it is necessary to treat air flows that can be greater than 20000 L/min, unless concentric tubes hundreds of meters long are used. A further limit of these systems is due to the use of covering materials chemically reacting with the pollutant. In fact, the use of these materials inevitably implies an exhaustion with time of the reactive capabilities of the covering, since the system causes a non-reversible chemical reaction determining the impossibility of a filter regeneration. Moreover, such a solution would have a limited functionality because any material can be reactive towards a certain class of pollutants but not towards all of them.

In view of the above, it is evident the need for a filtering system allowing not only an efficient removal of all the chemical weapons present in high amounts of air flows, but also having the capability of being regenerated in situ and therefore not giving problems of autonomy to the units provided with it.

The purpose of the present invention is therefore that of realising a filtering device for NBC weapons for treating big air volumes allowing for overcoming the limits of the solutions according to the prior art and for obtaining the previously described technical results.

Further aim of the invention is that said device can be realised with substantially limited costs, both as far as production costs and operative costs is concerned.

Not last aim of the invention is that of realising a filtering device for NBC weapons for treating big air volumes being substantially simple, safe and reliable.

It forms therefore a specific object of the present invention a filtering device for NBC weapons comprising a hermetically sealed box structure, provided with an opening for the inlet of air and/or gas to be filtered and an opening for the outlet of filtered air and/or gas, and inside which one or more plates are arranged defining the walls of a path for said air and/or gas from said inlet and said outlet, the side of the plates facing towards said path supporting a layer of an adsorbing material.

In particular, according to the invention, said plates are arranged parallel to each other, defining an interspace forming a straight portion of said course, and are arranged in a staggered way, each plate defining a free space close to the wall of the box structure, the subsequent plate defining a free space close to the opposed wall of the box structure.

Preferably, according to the invention, said plates support a layer of an adsorbing material on both sides and said plates are arranged between 0.1 cm and 5 cm apart from each other.

Alternatively, according to the present invention, said layer of an adsorbing material is made of a layer of carbon fibres with high surface area, preferably comprised between 1500 and 2000 m2/g, or said plates have perforated walls inside which said adsorbing material is contained, preferably constituted by activated carbon with high surface area in the form of granules or pellets, more preferably with a surface area of about 2000 m²/g or by activated zeolites, tufa or activated tufa.

Moreover, always according to the present invention, said filtering device can comprise a plurality of units arranged in parallel, some of said units being regenerated in counterflow while the others are working in normal flow condition.

It is evident the efficacy of the filtering device for NBC weapons for treating big air volumes of the present invention, having the advantage of being completely regenerable and not needing a periodic maintenance, such as the substitution of the exhausted filtering material as happens for the solutions according to the prior art, and needing a low energy consumption for its operation.

The invention will be describe for illustrative, non limitative purposes, with particular reference to some illustrative examples and to the figures of the enclosed drawings, wherein:

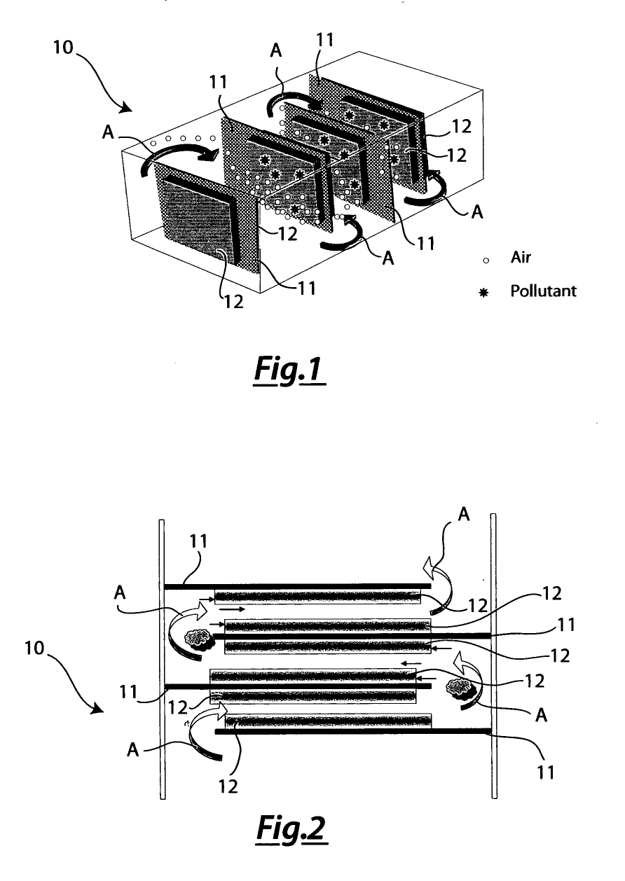

FIG. 1 shows a schematic perspective view of a filtering device for NBC weapons for treating big air volumes according to the present invention,

FIG. 2 shows a skematich top view of the device of FIG. 1,

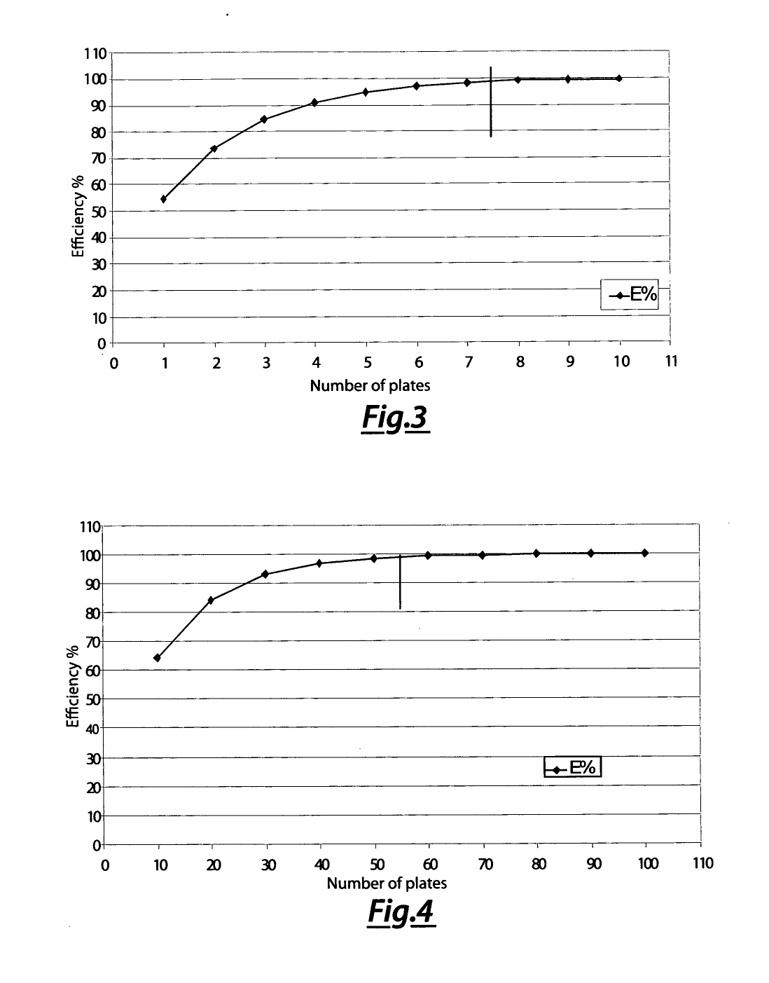

FIG. 3 shows a diagram illustrating the varying of the efficiency as a function of the number of plates for a small size filtering device for NBC weapons according to the present invention,

FIG. 4 shows a diagram illustrating the varying of the efficiency as a function of the number of plates for a big size filtering device for NBC weapons according to the present invention,

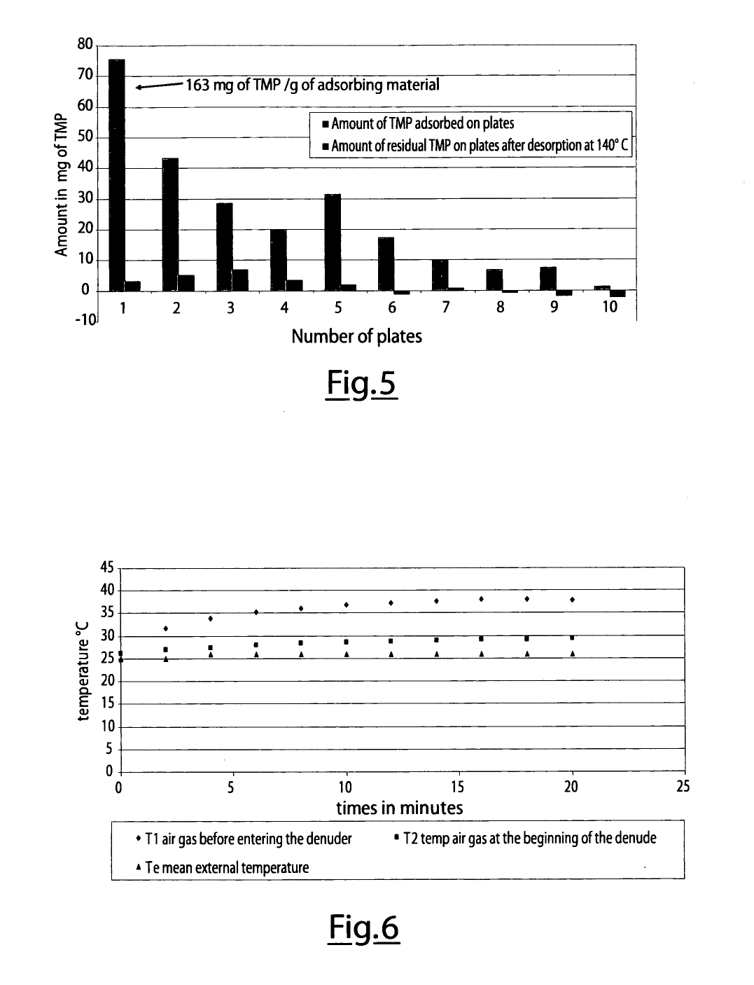

FIG. 5 shows a diagram illustrating the amount of trimethylphosphate adsorbed on the plates of a filtering device for NBC weapons according to the present invention through which an air flow as described with reference to example 1 passes,

FIG. 6 shows a diagram illustrating the varying of temperature as a function of time during the adsorbing step of an air flow as described with reference to example 1,

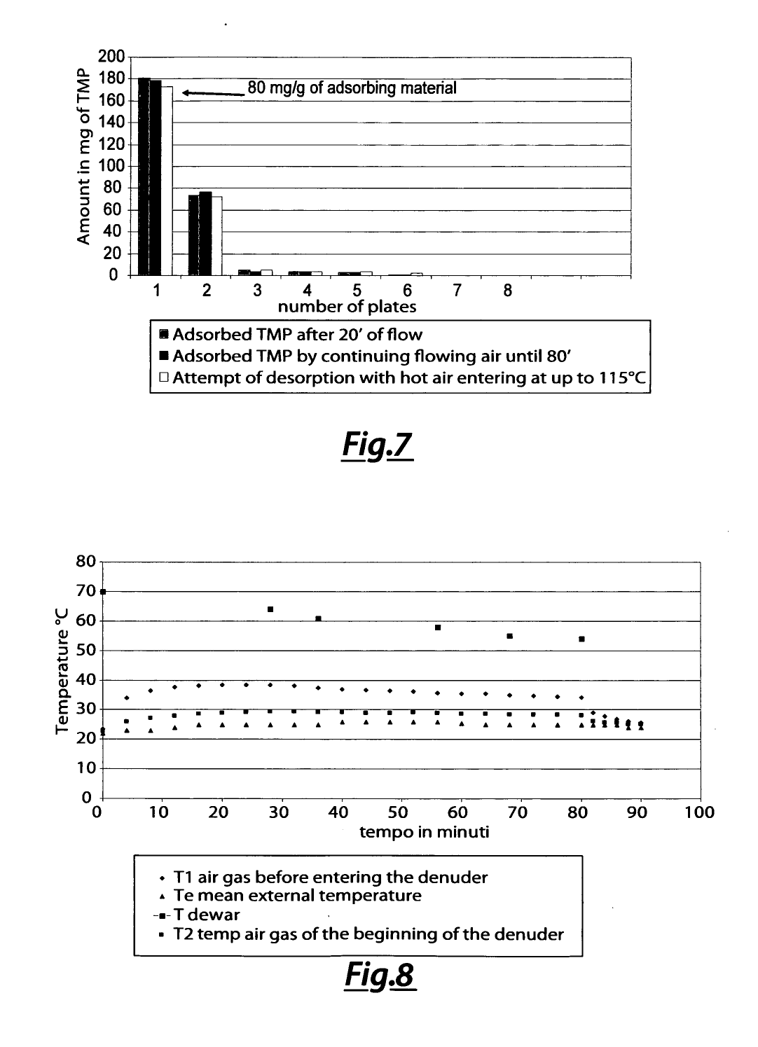

FIG. 7 shows a diagram illustrating the amount of trimethylphosphate adsorbed on the plates of a filtering device for NBC weapons according to the present invention through which an air flow as described with reference to example 2 passes,

FIG. 8 shows a diagram illustrating the varying of temperature as a function of time during the adsorbing step of an air flow as described with reference to example 2,

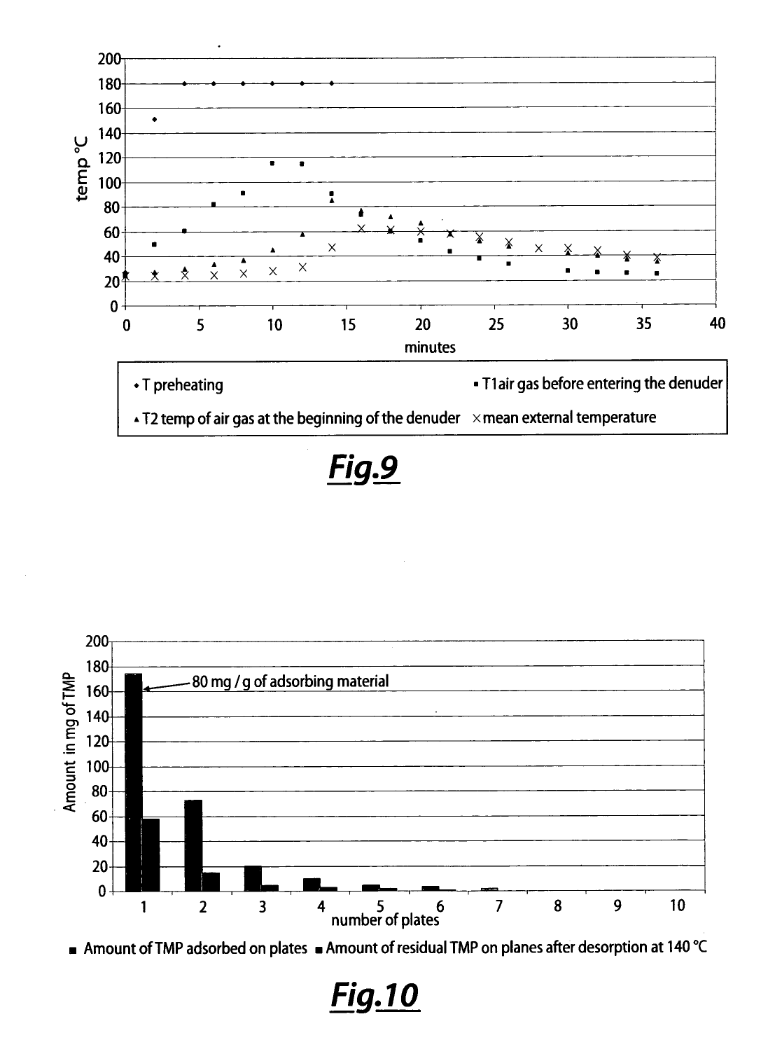

FIG. 9 shows a diagram illustrating the varying of temperature as a function of time during the desorbing step as described with reference to example 2,

FIG. 10 shows a diagram illustrating the amount of trimethylphosphate adsorbed on the plates of a filtering device for NBC weapons according to the present invention through which an air flow as described with reference to example 3 passes,

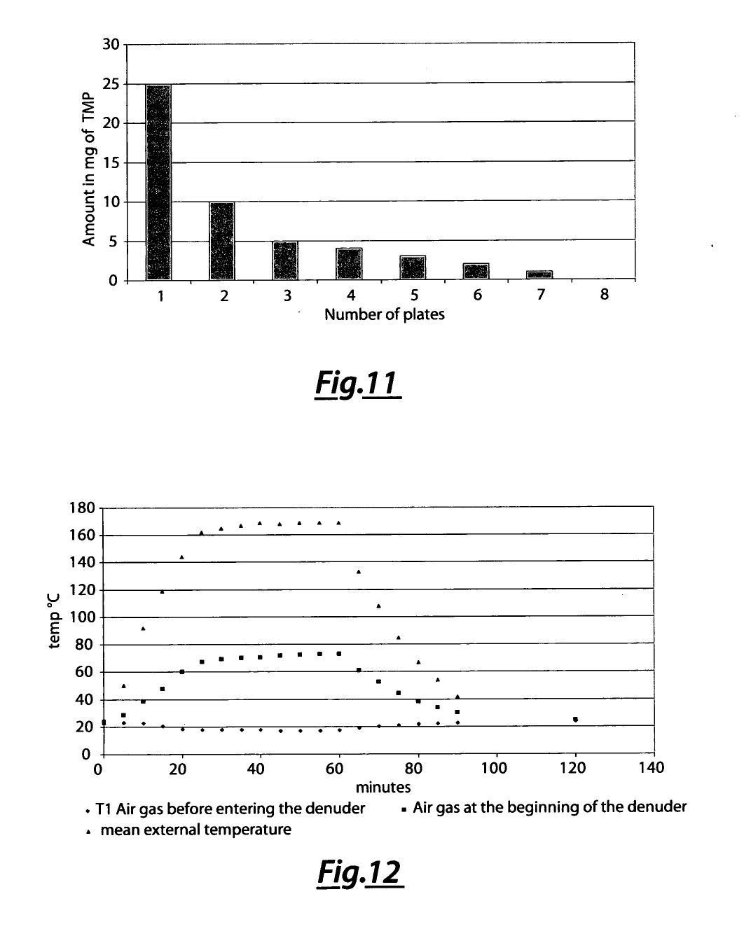

FIG. 11 shows a diagram illustrating the amount of trimethylphosphate adsorbed on the plates of a filtering device for NBC weapons according to the present invention after a desorbing step as described with reference to example 4,

FIG. 12 shows a diagram illustrating the varying of temperature as a function of time during the desorbing step as described with reference to example 4, e

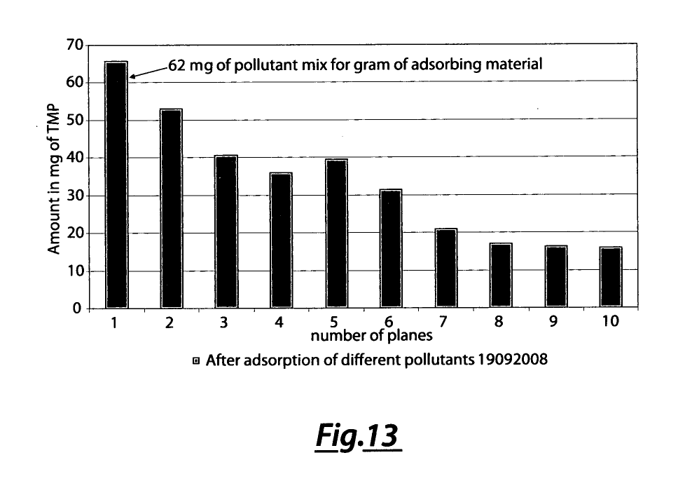

FIG. 13 shows a diagram illustrating the amount of pollutants adsorbed on the plates of a filtering device for NBC weapons according to the present invention through which an air flow as described with reference to example 5 passes.

The operative details of the filtering device for NBC weapons according to the present invention and its application in the military field will be better comprised by making reference to the following information on chemical weapons today present in military arsenals and on the respective stimulants, that is those chemical compounds being chemically similar to chemical weapons for war use with reference to the respective chemical-physical features, such as for example volatility and boiling point, but being enormously less toxic and consequently suitable for being used for experimental purposes and for testing of new and alternative solutions for the exhaustion of chemical weapons, thus avoiding to make direct use of such weapons.

As far as the different classes of chemical weapons is concerned, conventionally seven classes are acknowledged, going from tear gases (for example CN or chloroacetophenone, CS or orto-chlorobenzyliden-malononitril and CR or dibenzen(b,f)-1,4-oxiazepine), to irritants of the area nose-throat-bronchi (such as for example Clark I, Clark II, Adamsite), to psycotropic substances (for example BZ or benzilated 3-chinoclidinile), to vesicants (S-Mustard or iprite, N-Mustard or azotoiprite, Lewisite), to agents damaging the lungs (phosgene), to systemic poisons such as cyanidric acid and cyanogen alogenides, to nerve agents (Sarin, Ciclosarin, Soman, Tabun and VX).

Conventionally, the simulants that are mostly used are trimethylphosphate (TMP), triethylphosphate (TEP) and diethyl ethylphosphonate (DEEP), that are used to simulate the behaviour of nerve agents, essentially Sarin, one of the most common and volatile (with reference to the class). Simulants for vesicants are essentially dibutylsulphide (DBS) and 1,6-dichlorohexane (DCE). Lastly, for systemic poisons it is typical the use of cyanogen bromide (Br—CN) (cfr. Yin Sun and Kwok Y. Ong, Detection Technologies for Chemical Warfare Agents and Toxic Vapours, Boca Raton, Fla., 2005).

In the following examples, use will be made of these simulants, and in particular of trimethylphosphate in examples 1-4 and of a mixture of trimethylphosphate (TMP), dibutylsulphide (DBS) and 1,6-dichlorohexane (DCE) in example 5.

Making preliminarily reference to FIGS. 1 and 2, the layout geometry and the operating scheme of the filtering device for NBC weapons for treating big air volumes according to the present invention are shown.

In order to overcome the limits of the solutions according to the prior art, according to the present invention it is proposed a kind of “denuders” having a non cylindrical geometry, resulting to be more compact and suitable for high flows according to the specific needs.

Moreover, still maintaining the same operating concept based on the diffusion of the polluting gas, according to the present invention it is proposed to use, as a material for covering the walls, a fabric of carbon fibers having a very high surface per weight (up to 2000 m²/g). In other words, the polluting gas diffuses and an elastically bumps into the carbon material, being trapped physically and not chemically. This physical adsorbing turns out to be reversible and the adsorbing material can thus be regenerated.

Making reference to the geometry of the filtering device for NBC weapons for treating big air volumes according to the present invention, FIGS. 1 and 2 show that the device is constituted by a main body, indicated as a whole with the numeric reference 10, having a “box-like” geometry, i.e. the shape of a hermetically sealed parallelepiped, inside which many metal plates 11 are arranged supporting on each side a layer 12 of adsorbing material i.e. the fabric of carbon fibers. The assembly of each plate 11 with the respective layers 12 of adsorbing material will be also indicated in the following by the term plate. Plates 11 are arranged according to a Derner type configuration, i.e. staggered with respect to each other so to determine a “coil” path for the air flow (represented by the arrows indicated with letter A) and so that the interspace between them can be regulated in the range from 1 and 4 mm.

The system can be defined an open system and does not present any head pressure load. This feature is very important in cases, as those for which the filtering device 10 for NBC weapons according to the present invention was proposed, in which it is necessary to treat big amounts of air. In fact, when operating with air flows of the order of many hundreds of m³/h, it is necessary to take into consideration the pressure load occurring at the head of the adsorbing system. Using the filtering systems according to the prior art, such load can become considerable and can be overcome only by using big compressors, with the consequence of a notable energetic consumption.

The filtering device 10 for NBC weapons for treating big air volumes according to the present invention presents the advantage, with reference to its configuration, that it does not imply any head load. Consequently, it operates also with a simple air conveyor, with the big advantage of an important energetic saving.

In passing the filtering device 10 for NBC weapons for treating big air volumes according to the present invention, the air containing the gaseous pollutant is forced to pass between two layers 12 of adsorbing material spaced apart from each other only a few millimeters. The gaseous pollutant collides by diffusing with the layers 12 of adsorbing material and remains trapped. The total path of the polluted air is long enough and obviously depends on the number of plates 11 (with two sides with an adsorbing layer 12) arranged within the device 10.

It is possible to estimate how many plates 11 are needed for completely adsorbing the pollutant by applying the following physical formula for the calculation of the efficiency of the filtering system:

E(%)=100(1−m₂/m₁)

wherein m₂/m₁ indicates the ratio between the amount of pollutant on the last plate with respect to the first and can be determined by the following formula (valid for a classical anular “denuder” with a cylindrical geometry and adapted to the kind of filtering device for NBC weapons for treating big air volumes according to the invention, linear “denuder” with “box-like” geometry, by developing the dimensions of the plates of adsorbing material and representing them as a long double concentric cylinder with a circular ring of a few millimeters):

m₂/m₁=0.82exp[−22,53·πD·L·(do+di)/4F·(do−di)]

wherein D is the diffusion coefficient of the pollutant expressed in cm²/s, L is the length of the denuder expressed in cm, F is the air flow expressed in cm³/s, do is the diameter of the external tube expressed in cm and di is the diameter of the internal tube expressed in cm.

From the formula results that the efficiency of the system is exponentially proportional to the gas diffusion coefficient and to the length of the denuder. The air flow has an inverse effect, that is the higher is the flow, the lower is the efficiency. Also the interspace plays an important role, efficiency decreasing when the interspace increases.

On the base of the formula of efficiency above, it was possible to determine the theoretical trend of the filtration efficiency of a filtering device for NBC weapons according to the present invention as a function of the number of plates. In particular, FIGS. 3 and 4 show a diagram illustrating the varying of the efficiency as a function of the number of plates for two filtering devices for NBC weapons according to the present invention, different from each other in particular as far as the number and dimensions of plates, the size of the interspace between the same plates and the flow of air is concerned.

The case represented with reference to FIG. 3 is a simple model with reduced dimensions, i.e. with square plates with double layer of a carbon fibre adsorbing fabric and having square dimensions of 4 cm per side, air flow of 10 L/min, interspace between the plates of 1 mm.

Applying the formula it was calculated that it is possible to reach almost an efficiency of 100% on the eighth plate on a total of ten plates taken into consideration.

The case represented with reference to FIG. 4 is on the contrary a model having greater size, much more approaching to a real application and in which square plates are provided with double layer of carbon fibre adsorbing fabric and square dimensions of 70 cm per side, air flow of 20000 L/min, interspace between the plates comprised between 1 and 5 mm (varying this parameter within these limits does not appreciably affect efficiency). In this second case it was calculated that it is possible to almost reach 100% efficiency at the sixtyfifth plate on a total of plates taken into consideration.

The experimental tests reported below were done by using the following operative system.

Air coming from a cylinder was passed in a fluxmeter and then, by means of a tap, in an empty tube of steel that if needed can be heated thus helping the volatilisation of the used simulant, in particular trimethylphosphate (TMP) or a mixture thereof with dibutylsulphide (DBS) and 1,6-dichlorohexane (DCE). Downstream the steel tube, the air flow is passed in a washing bottle, within which a set amount of simulant trimethylphosphate or a mixture of simulants was previously put. The washing bottle was kept totally heatet in a thermostatic bath at 800° C. and hot air coming out carried trimethylphosphate at a concentration of 7.6 g/m³. Operating with a flow of 2.1 L/min, this implied that the TMP flow that flew within the filtering device for NBC weapons for treating big air volumes according to the present invention was equal to 16 mg/min. Such a model system simulates at the best the actual introduction of air and pollutants contained therein. Subsequently the air and simulant flow was passed in a manometer in order to avoid that a head pressure load could occur, a double temperature control was performed on outlet gases from the washing bottle and then the connection with a filtering device for NBC weapons for treating big air volumes according to the present invention (“box-like denuder” Derner kind) inside which eight plates 11 are provided supporting a layer 12 of carbon adsorbing material on each of the two sides and square dimensions of 4.2 cm per side. At the outlet of the filtering device a connection was realised with a glass coil immersed in liquid nitrogen. In this way it was possible to trap any minimal amount of simulant eventually coming out from the system because it was not hold by the filtering device. By knowing the amount of simulant introduced within the washing bottle upstream and measuring the amount of simulant collected within the glass coil, downstream, it was possible to derive the TMP trapping efficiency (the yeld) of the filtering device according to the present invention.

In the following examples, the results are reported obtained for the exhaustion of simulants of chemical weapons in air in the model above.

After each TMP adsorbing cycke, the filtering device was further opened for removing and weigh any single plate. After subtracting the tare, it was theoretically possible to determine the amount of TMP adsorbed on each of them. Actually this operation put in evidence that the carbon based adsorbing materials applied on the plates of the filtering device had a notable propension to adsorb air humidity during the time required for the procedures of unmounting, opening and weighing. The detected values, therefore, cannot be considered as absolute values since the value of each single plate weighing is affected by this systematic error. However, in the following examples will be also presented the data obtained from the weighing of the single plates, because, being all homogeneously affected by the same systematic error, they provide an indicative data of the TMP distribution along the path between the different plates of the filtering device.

In all the following examples reference is made to the following parameters.

The adsorbing material is realised with carbon fibre and was used both as a felt having a thickness of about 2 mm, and as a fabric having a thickness of about 0.5 mm. Generally more layers of felt and/or fabric were placed one on another, for each side of the plate, so to reach a thickness of material of maximum 5 mm for each side of the plate. The development of the surface area of these materials was varied between 1500 and 2000 m²/g.

The adsorbing volume per plate is the adsorbing material geometric volume present on the two sides of the plate. It is determined from the size of the plate, generally of a squared shape, with side between 4 and 4.2 cm, and taking account of the thickness of the layer of used adsorbing material. Such volume was varied between 9 and 19 cm³.

The surface development per plate represents the active surface of the adsorbing material. It was determined based on the weight of material present on the two sides of the plate and taking into consideration the specific surface area (m²/g). This value resulted varying between 920 and 4475 m².

By number of plates were indicated the plates contained within the model of filtering device of the invention. The plates were rigidly bound to one another by means of a passing through screw, realising a staggered distribution of Derner type. Device models were used with a number of plates comprised between 8 and 25.

The interspace between plates is the distance between the layer of adsorbing material placed on a side of a plate and the layer of an adsorbing material placed on the opposed side of the following plate. This value is constant for all the plates of the same model. The values used for the different models used for the examples are comprised between 1.1 and 2.1 mm.

By the term linear air path was indicated the total length of the “coiling” path covered by the laminar air flow to pass in the interspaces formed by the different plates. Depending on the different examples this value was varied between 42.4 and 36.8 cm.

By regenerated is indicated the number of times that the adsorbing material present on the sides of the plates underwent a regeneration before being used in the example. The re generation was performer by heating the filtering device of the invention in a counterflow of clean air at about 140-160° C. (external temperature). Different systems were regenerated even 7 times.

The air flow is the air flow coming from a cylinder and measured by means of a fluxmeter. Flows were applied between 5 and 50 L/min.

By trimethylphosphate TMP was indicated the amount of trimethylphosphate placed within the washing bottle and transported within the filtering device by the air flow that was passed into the bottle. In all the different examples 250 mg di TMP were always used.

By concentr.TMP in air it was indicated the concentration of TMP in the carrier air coming out from the washing bottle maintained at a constant temperature of 70° C. This value (which was assumed to be homogeneous during all the time needed for the TMP volatization) depends on the thermostating temperature of the washing bottle and on the air flow. For a flow of 5 L/min a 70° C. this value was calibrated in 2.625 microliters of TMP for each liter of flowing air or 3.150 g of TMP for each m³ of air, corresponding to about half the TMP vapour tension at ambient temperature. For informative purposes, it is reminded that the technical specifications for this kind of devices require for a TMP concentration in air of 1 g/m³. Under the conditions of the experimental tests reported in the following examples, in order to introduce 250 mg of TMP into the filtering device with an air flow of 5 L/min about 80 L of air must flow taking about 16 minutes.

By the term equivalence it is indicated a comparative model with the same homogeneous TMP concentration in air that would occur after the explosion of an explosive device. In order to obtain a TMP concentration in air of about 3 g/m³ (i.e. that of the reported examples) an sphere of explosion with a radius of 25 m should occur homogeneously distributing 200 kg of TMP.

The term air flown in the decanter indicates the total amount of air passed into the filtering device. With aflos of 5 L/min, at least 80 liters of air must flow in order to introduce the entire amount of TMP loaded in the washing bottle. In general, 20 liters of air more were passed in order to assure a quantitative introduction. Sometimes many more liters of clean water were passed (up to 600 liters) in order to understand possible movements of the adsorbed TMP between the different plates of the “denuder”.

Lastly, by Inhaled TMP per minute it was indicated the amount of TMP inhaled by a man doing twelve inspirations in one minute with total absorption of the inhaled pollutant. It is assumed that any inspiration corresponds to 5 Liters of polluted air. The concentration of TMP in air used for the reported examples, i.e. 3.15 g/m³, corresponds, in case it is inhaled by a man, to 189 mg/min of inhaled TMP (LCₜ₅₀ limit for SARIN is 6 mg/min, cfr. Cataldo, Op. Cit.).

### EXAMPLE 1

Adsorbing material: Felt 2000 m²/g

Regenerated: 5 times

Adsorbing volume per plate: 9 cm³

Surface development per plate: 920 m²

N° plates: 10

Interspace between plates: 1.4 mm

Linear air path: 42.4 cm

Air flow: 5 L/min

Simulant: Trimethylphosphate TMP: 250 mg

Concentr.TMP in air: 2.625 microL/Lₐᵢᵣ or 3.150 g/m³

Equivalence: radius of sphere of explosion 25 m with 200 kg of TMP

Air flown in the decanter: 100 L

Inhaled TMP per minute: 189 mg/min (limit LCₜ₅₀ SARIN: 6 mg/min)

The test, lasting 20 minutes, allowed to determine a TMP adsorbing yeld, calculated as a function of the simulant amount trapped in the glass coil immersed in liquid nitrogen downstream the filtering device, equal to 98.171% with respect to the total.

With reference to FIG. 5, it clearly emerges a trend of the almost exponential kind for the TMP adsorption on the different plates placed in order within the filtering device of the present invention. The maximum adsorbing percentage on a single plate, under the conditions of use, was 16.3% (weight/weight). This is a number by defect, because it is calculated on the base of the total weight of the adsorbing material that is present on the plates, but probably not the entire thickness, and thus weight, of the material is involved in TMP adsorption. On the contrary it is likely that the surface layers are, but it is difficult to quantify it in terms of weight.

It has underlined that also the tenth and last plate presents a minimum amount of TMP, leaving it possible to suspect that a still minor amount of TMP was not trapped and therefore came out from the filtering device. In fact, the adsorbing yeld is not equal to 100%. The causes of it can be various: a too poor number of plates and thus a too short gas linear route, a non optimal kind of adsorbing material, a non optimal thickness of the adsorbing material (about 2 mm), a too great interspace between the plates.

FIG. 5 also shows the presence of TMP residuals on the plates after regeneration by desorption of the same. In particular, said step of regeneration by desorption was performed with a clean air counterflow of 10 L/min, heating the filtering device from the outside up to 140° C. In these conditions, the actual temperature of the air when passing within the filtering device, taken at the exit, did not overcome anyway a value of 85° C.

In the diagram shown in FIG. 6 the trends of temperature are shown calculated during 20 minutes of the adsorbing step. Such a control is needed because the TMP adsorption on the carbon materials being used is exothermic.

T₁ is the temperature of the polluted air taken at the exit from the washing bottle. This value increases until about 38° C.

T₂ is the temperature of the polluted air taken at the inlet of the filtering device (practically in contact with the first plate). This value increases until about 30° C.

Tₑ is the temperature taken at the outlet of the filtering device. This value is practically constant 26° C.

### EXAMPLE 2

Adsorbing material: Fabric 2000 m²/g+Felt 2000 m²/g

Regenerated: 6 times

Adsorbing volume per plate: 19 cm³

Surface development per plate: 4475 m²

N° plates: 8

Interspace between plates: 1.1 mm

Linear air path: 36.8 cm

Air flow: 5 L/min

Simulant: Trimethylphosphate TMP: 250 mg

Concentr.TMP in air: 2.625 microL/Lₐᵢᵣ or 3.150 g/m³

Equivalence: radius of sphere of explosion 25 m with 200 kg of TMP

Air flown in the decanter: 100 L-300 L-200 L

Inhaled TMP per minute: 189 mg/min (limit LCₜ₅₀ SARIN: 6 mg/min)

TMP adsorption yeld: 99.995%

In this example some important modifications were introduced with respect to the previous example. In particular, two different kind of carbon adsorbing material were used for a thickness on each side of the plate of about 5 mm and a surface development much higher than the previous case. Moreover, the interspace between the plates was smaller and within the filtering device only eight plates were positioned, for a linear air path shorter than the previous case. For the rest, the square plates geometrical dimensions are identical to the previous case.

The test was performed in particular conditions. After the first 20 minutes of adsorption, occurring in the same way as in the previous case (100 liters of air), 60 minutes follow of pollutant free air flow (300 liters). This air was flown in the washing bottle and heated there, and subsequently entered into the filtering device. After, for about 40 minutes a clean air flow (200 liters) was passed, being pre-heated for the first 15 minutes up to 180° C. entering the filtering device at a temperature increasing with time up to a maximum temperature of 115° C. (FIG. 9).

The logic of these tests was to comprehend if a prolonged air flow hot on the average or very hot could modify or not the TMP. distribution initially adsorbed on the single plates of the filtering device.

FIG. 7 clearly shows a TMP adsorption of a quasi exponential type on the various plates-placed in order within the filtering device. The maximum percentage of adsorbed on a single plate, in conditions of use, was of about 8% (weight/weight). This is a number by defect, because it is calculated on the base of the total weight of the adsorbing material that is present on the plates, but probably not the entire thickness, and thus weight, of material is involved in TMP adsorption. On the contrary it is likely that only surface layers are involved, and they cannot be quantified in terms of weight. The fact that in this case a percentage value much lower that the previous case was obtained, gives value to what was described previously. In fact, in this case an amount of adsorbing material the weight of which is higher than the previous case and the percentile adsorbing correctly results lower.

The last two plates (the seventh and the eighth) did not have the minimum amount of TMP, obviously giving hope that not even a minimum amount of TMP can be non trapped and thus come out from the filtering device itself. In fact, the adsorbing yeld turns out to be very close to 100%. The reasons for this can be different. In fact, despite a lower number of plates and a shorter gas linear path than the previous case, the type of adsorbing material could be the optimal one, i.e. the thickness of the adsorbing material could be optimal (circa 5 mm), or also the interspace between the plates could be optimal.

FIG. 7 shows also that the distribution of initially adsorbed TMP on different plates was not changed after a cleaning for 60 minutes with clean air at an on the average hot temperature, not even after a washing of about 40 minutes made with very hot air, up to 115° C. (FIGS. 8 and 9). This means that the physical interaction formed between TMP and carbon material is really strong and anyway assures that once the pollutant is adsorbed, any normal washing cannot move the poison away from the material in which it is trapped.

FIG. 8 shows the trend of temperatures measured during the 20 minutes of the adsorbing step and the following 60 minutes, during which clean air flow was passed first in the washing bottle (without TMP) and then on the filtering device.

In FIG. 8, T₁ represents the temperature value for air taken at the exit from the washing bottle. This value increases up to a maximum value of about 38° C.

T₂ is the temperature of the air at the inlet of the filtering device (in practice in contact with the first plate). This value increases up to a maximum value of about 30° C.

Tₑ is the temperature measured at the exterior of the filtering device. This value remains practically constant at 25° C.

In FIG. 9, on the contrary are represented the temperature trends measured during the 35 minutes of the following step during which a clean air flow was passed in a tube made of steel (pre-heater), heated at 180° C. for the first 15 minutes, and subsequently entered in the filtering device, in order to verify a possible desorption and moving away of TMP from plates.

T₁ corresponds to the temperature value of washing air measured immediately before it enters the filtering device. This value increases up to a maximum value of about 115° C.

T₂ corresponds to the value of air temperature measured at the inlet of the filtering device (practically at contact of the first plate). This value increases up to a maximum value of about 84° C.

Tₑ is the temperature measured at the outlet of the filtering device. This value increases up to a maximum value of about 64° C.

It is possible to conclude that, at least for the temperature conditions of the test, with the flows and time periods used, no displacement of TMP occurs from the plates in which it was originally adsorbed.

### EXAMPLE 3

Adsorbing material: Fabric 2000 m²/g+Felt 2000 m²/g

Regenerated: 2 times

Adsorbing volume per plate: 19 cm³

Surface development per plate: 4475 m²

N° plates: 8

Interspace between plates: 2.1 mm

Linear air path: 36.8 cm

Air flow: 5 L/min

Trimethylphosphate TMP: 250 mg

Concentr.TMP in air: 2.625 microL/Lₐᵢᵣ or 3.150 g/m³

Equivalence: radius of sphere of explosion 25 m with 200 kg of TMP

Air flown in the decanter: 100 L

Inhaled TMP per minute: 189 mg/min (limit LCₜ₅₀ SARIN: 6 mg/min)

In the test of this example only one modification was made with respect to example 2, the condition of which seem to be optimal, and in particular the interspace between the plates was increased up to 2.1 mm. Such a modification was made in order to understand what can be the effect of the interspace on the adsorbing capacity of the system.

From the diagram shown in FIG. 10 it clearly emerges an almost exponential trend of TMP adsorption on the various plates placed in order within the filtering device. The maximum percentage adsorbed on a single plate, in conditions of use, was about 8% (weight/weight). This is a number by defect, because it is calculated on the base of the total weight of the adsorbing material that is on the plates, but probably not all the thickness, and therefore the weight, of the material that will be involved in the TMP adsorption. It is likely that only surface layers are involved, being difficult to quantify in terms of weight. In this case, the same value obtained with respect to that of the second set of results demonstrates that increasing the interspace up to values being almost doubled does not affect the adsorbity capacity of the filtering device.

In these conditions also, the last plate (the eighth) did not have the minimum amount of TMP, obviously leaving hope that any minimum amount of TMP cannot be trapped and thus come out from the filtering device. In fact, the adsorbing yeld measured is very close to 100%. It ignote only a little yeld decreasing with respect to the case of the second set of results, which is in line with the fact that in this case it is involved also the seventh plate of the denuder.

FIG. 10 shows also the presence of a certain residual of TMP on the plates also after the step of regeneration by desorption with clean air in counterflow at 10 L/min for 60 minutes, and heating the filtering device from outside at 140° C. In these conditions, the actual temperature of the air passing through the filtering device, measured at the outlet of the filtering device itself, does not overcome anyway 85° C. At these temperature values there is not a big displacement of the adsorbed TMP, as was also seen from the tests of the example 2 (with hot air flow of 5 Liters/minute for 35 minutes). In the present case, TMP manages to be at least partially desorbed thanks to the higher flow and the longer desorption time.

### EXAMPLE 4

### Desorption Test

Adsorbing material: Fabric 2000 m²/g+Felt 2000 m²/g

Regenerated: 5 times

Adsorbing volume per plate: 19 cm³

Surface-development per plate: 4475 m²

N° plates: 8

Interspace between plates: 1.1 mm

Linear air path: 36.8 cm

Air flow: 10 L/min

Trimethylphosphate TMP: 250 mg

Concentr.TMP in air: 2.625 microL/Lₐᵢᵣ or 3.150 g/m³

Equivalence: radius of sphere of explosion 25 m with 200 kg of TMP

Air flown in the decanter: 1200 L

Inhaled TMP per minute: 189 mg/min (limit LCₜ₅₀ SARIN: 6 mg/min)

Desorption yeld of collected TMP, at the outlet of the “inverted” filtering device of the invention, with liquid nitrogen:

| | |
|---|---|
| Recovered TMP | 50% |
| Decomposition products: | 30% |
| Residual TMP on plates: | 19% |
| CO₂: | 1% |

The tests of this example represent the steps of regeneration by desorption. Operative parameters used are the same as for example 2. In the present case we worked with the filtering device of the invention mounted in inverted way, i.e. making the air flow (10 litres per minute for 60 minutes) pass in an inverted direction with respect to that of the adsorption step. All the desorbed products were condensed and trapped in liquid nitrogen and then underwent a gas-chromatographic analysis in order to determine the desorption yeld.

The heating for the filtering device was provided from outside by wrapping a heating ribbon around the filtering device and measuring the temperature with a thermocouple. Previously, the filtering device underwent two classic TMP adsorbing cycles, under the same operative conditions of example 2.

FIG. 11 shows the TMP amount, expressed in mg, still adsorbed on the different plates after the desorbing step. FIG. 11 shows a neat residual of TMP (about 19% with respect to a single charge of 250 mg of TMP) on the plates, also after the step of regeneration by desorption with clean air, in counterflow at 10 L/min for 60 minutes, and heating the filtering device of the invention from outside at about 160° C. In these operative conditions, the actual temperature of the air passing through the filtering device, measured at the outlet of the filtering device itself, did not overpass 85° C. At such a temperature there is not a big displacement of the adsorbed TMP, as was also seen from the tests of the example 2 (flow 5 L/min for 35 minutes). In this case, at least a part of TMP can be desorbed, thanks to the higher flow and the longer desorption time.

It is considered that a heating of the filtering device from the inside should be much more efficace, reaching higher temperatures. In these conditions, TMP should be completely desorbed and the filter totally regenerated.

Anyway it has to be underlined that, also under conditions of partial desorption as those obtained according to the present example, the filter is able to operate with success a subsequent adsorbing step, as demonstrated by the fact that, also in the previous examples, many of the used plates previously underwent different partial regeneration steps (up to seven), with excellent results in the following adsorbing step.

FIG. 12 shows temperature trends measured during the 60 minutes (and the following 20 minutes for cooling) of the desorbing step. T₁ is the temperature of the air measured at the inlet of the filtering device of the invention, mounted in inversed way. This value remains constant at about 20° C. T₂ is the temperature of the at the outlet of the filtering device of the invention (in practice in contact with the first plate that, being the filtering device inverted, corresponds to the outlet of the same). This value increases up to about 78° C. Tₑ is the temperature measured outside the filtering device during the step of heating by means of an electric ribbon. This value increases up to about 168° C.

Starting from the gas-chromatographic analysis of the products, it was possible to determine the amount of the different compounds released in the desorbing step. It was possible to see about 30% of ecomposition product and 50% of unhaltered TMP. It was also determined the presence of 1% of CO₂, evidently deriving from the catalytic combustion of the organic pollutant on the carbon of the used fabrics, in particular at high temperature. The last process is anyway very limited, and thus does not involve an unacceptable consumption of the carbon material with time.

### EXAMPLE 5

### Adsorption of Three Pollutants in Mixture with a Flow of 50 L/min

Adsorbing material: Felt_{(new type)} 2000 m²/g+Felt_{(new type)} 1500 m²/g

Regenerated: 2 times

Adsorbing volume per plate: 14.4 cm³

Surface development per plate: 1882 m²

N° plates: 10

Interspace between plates: 1.1 mm

Linear air path: 44 cm

Air flow: 50 L/min

Total air passed through the filtering device: 1500 L (of which the first 150 L contain the mixture of the three pollutants and the other 1350 L are clean washing air).

Composition of the mixture passing through the filtering device, evaporated simultaneously from the washing bottle:

Trimethylphosphate TMP: 150 mg evaporated from the washing bottle in 3 minutes at 84° C.

TMP concentration in air: 0.833 μL/Lₐᵢᵣ or 1.000 g/m³ (⅙ vapor pressure)

Equivalence: radius of sphere of explosion 25 m with 65.6 kg TMP

Inhaled TMP per minute: 60 mg/min (limit LCₜ₅₀ SARIN: 6 mg/min)

Dibutyldisulfide DBS: 150 mg evaporated from the washing bottle in 3 minutes at 84° C.

DBS concentration in air: 1.066 μL/Lₐᵢᵣ or 1.000 g/m³ ( 1/250 vapor pressure)

Equivalence: radius of sphere of explosion 25 m with 65.6 kg of DBS

Inhaled DBS per minute: 60 mg/min (limit LCₜ₅₀ IPRITE: 90 mg/min)

1.6 Dichlorohexane DCE: 150 mg evaporated from the washing bottle in 3 minutes at 84° C.

DCE concentrazione in air: 0.936 μL/Lₐᵢᵣ or 1.000 g/m³ (⅙ vapor pressure)

Equivalence: radius of sphere of explosion 25 m with 65.6 kg DCE

Inhaled DBS per minute: 60 mg/min (limit LCₜ₅₀ IPRITE: 90 mg/min)

Adsorbing yeld of any collected pollutants, at the outlet of the filtering device, by using liquid nitrogen (determined according to the previously described).

| | |
|---|---|
| Trimethylphosphate TMP: | 95.846% |
| Dibutyldisulfide DBS: | 95.541% |
| 1,6 Dichlorohexane DCE: | 89.951% |
| Average adsorbing yeld | 93.793% |

For the tests of this example we operated by passing through the filtering device of the invention a mixture of pollutants (TMP, DBS, DCE) each at a concentration of 1 g/m³, with a flow of 50 L/min. During the entire duration of the test, no head pressure load was observed.

For TMP the used concentration was largely above the value LCₜ₅₀ SARIN: 6 mg/min and for DBS and DCE was lower than the relative LCₜ₅₀ IPRITE: 90 mg/min, but it was preferred to operate with the same concentrations in order to understand the possible difference of behaviour towards the adsorption on the carbon materials.

FIG. 13 shows that the trend of the amount of pollutants adsorbed on the single plates is not of quasi exponential type, as for the previous examples, but rather very similar to a decreasing linear trend. This can be understood if account is taken of the higher amount of pollutants used with respect to the previously described tests and of the higher flow operated. Both these factors implies a more homogeneous distribution of the amounts that are adsorbed along the plates of the filtering device of the invention. Also in this case is anyway observed a percentage of adsorbed pollutants per gram of adsorbing material in line with the tests previously described.

Moreover, also the last plate (the tenth) is largely involved in the adsorption indicating that a substantial amount of pollutants came out from the filtering device. Indeed, from the gas chromatographic control of the eluate, totally condensated in liquid nitrogen, it comes out an average trapping of about 94%, with a neat preference for TMP and DBS with respect to DCE.

This result, that can seem unsatisfactory with respect to the trapping amount of example 2, is on the contrary largely positive account being taken that all the comparisons were made with respect to the results of example 2, taken as a reference, due to the quantitative adsorption that was verified in that case. Moreover, in the case of the present example, the adsorbing material being used is different but can be considered an excellent material itself. The volume of the adsorbing layer on the sides of the plate is smaller in the case of the present example and this could have an important role. Further, the surface development of the adsorbing layer of the plate is smaller and this also could be important. The interspace between the plates is the same and the gas linear path is slightly longer because in the case of the present example a higher number of plates is present.

Moreover, the air flow is 10 times higher in the present case, and this is a very important parameter to the aim of adsorbing possibilities towards pollutants. In fact, as already said, if the conditions of the second example are the best for the model system, it must be considered as a scale factor the ratio between flows and adapt to this the surfaces of the plates. In such a way, it was possible to maintain the optimal operative parameters, analoguous to those of the model system.

In fact, in the model system (constituted by the operative conditions set in example 2) the total geometric area of the adsorbent surfaces is 324 cm² and it was possible to operate with a flow of 5 L/min. In the case of the present example, on the contrary, it is applied a flow that is 10 times higher, so that, if the same performances are desired, the total geometric area of the adsorbing surfaces should be 3240 cm². On the contrary, the value of the total geometric area of the adsorbing surfaces the system of the present example is only 319 cm², i.e. about 10% the value deriving from the scale ratio with the model system. Notwithstanding this very important drawback, the system adsorbs up to 94% of the pollutants introduced in the filtering device, and without any head pressure load.

It is evident that, by disposing of a filtering device with plates developing a geometrical surface about 10 times greater than that used in this example, the adsorbing power of such a system would easily increase up to 100%.

An important factor, that is always necessary to take into consideration, is that regarding the size and molecular weight of the pollutants or aggregates that they can form in the ambient of the explosion where they are. The filtering device of the invention operates, as said, on the logic of the diffusion of the polluting gas and this is much higher, favoring the adsorption, as the kinetic energy associated with the gas molecules (or aggregates) is lower. As previously said, macroscopic particles are not adsorbed. An indicative estimate of such energy comes from the Boltzman energy that, at ambient temperature, is about 0.0387 eV. A calculation of translational kinetic energy can easily indicate how much it is far from the value according to Boltzman. The translational kinetic energy obviously depends from the mass and velocity of the pollutants molecules or molecular aggregates. As far as the aggregate is concerned, it is not possible to know the entity of their mass, but an hypotheses around 20000 Dalton can be largely conservative and leaves the aggregates in the range of nanostructure. As far as the velocity is concerned it is possible to say that it will surely depend from the air flow, from the free volume that such air will pass through (the greater possible in order to limit the value of the velocity itself), and from the linear path to be covered (the shorter as possible in order to limit the value of the velocity).

The balance of these factors must assure the lowest translational kinetic energy and as a consequence will also determine the physical geometry that the filtering device must have. In the case in question, this value is very close to that of Boltzman and the velocity of the molecules or aggregates is only 6.7 cm/second.

The embodiments of the present invention can be different, within the scope of the teachings of the preceding disclosure. In particular, in order to work with big flows comprised for example between 350 and 1400 m³/h, the filtering device according to the present invention could be assembled in more units so to respond to requested filtration volumes and further to allow some units to enter into regeneration mode in counterflow while others are working with normal flow.

The present invention was described for illustrative, non limitative purposes, according to its preferred embodiments, but it has to be understood that variations and/or modifications can be made by the skilled in the art without for this reason escaping the pertinent scope of protection, as defined by the enclosed claims.

1. Filtering device for NBC weapons, characterised in that it comprises at least one unit constituted by a hermetically sealed box structure (10), provided with an opening for the inlet of air and/or gas to be filtered and an opening for the outlet of filtered air and/or gas, and within which a plurality of plates (11) are arranged to define the walls of a laminar flow path for said air and/or gas from said inlet and said outlet, the sides of the plates (11) facing said laminar flow path supporting a layer (12) of a physically adsorbing material by diffusion.

2. Filtering device according to claim 1, characterised in that said plates (11) are arranged parallel to each other, defining an interspace forming a straight portion of said laminar flow path, and are arranged in a staggered way, each plate (11) defining a free space close to the wall of the box structure (10), the subsequent plate (11) defining a free space close to the opposed wall of the box structure (10).

3. Filtering device according to claim 1, characterised in that said plates (11) are arranged between 0.1 cm and 0.5 cm apart from each other.

4. Filtering device according to claim 1, characterised in that said layer (12) of a physically adsorbing material is made of a material that can be regenerated at a temperature below 160° C.

5. Filtering device according to claim 1, characterised in that said plates (11) support a layer (12) of a physically adsorbing material on the exterior of both sides.

6. Filtering device according to claim 5, characterised in that said layer (12) of a physically adsorbing material is made of carbon fibres with high surface area.

7. Filtering device according to claim 5, characterised in that said layer (12) of a physically adsorbing material is made of a layer of carbon fibres with a surface area comprised between 1500 and 2000 m²/g.

8. Filtering device according to claim 1, characterised in that said plates (11) are hollow and have perforated walls, said plates (11) supporting a layer (12) of a physically adsorbing material on the interior of both sides.

9. Filtering device according to claim 8, characterised in that said physically adsorbing material consists of activated carbon with high surface area in the form of granules or pellets.

10. Filtering device according to claim 9, characterised in that said physically adsorbing material has a surface area of about 2000 m²/g.

11. Filtering device according to claim 8, characterised in that said physically adsorbing material consists of activated zeolites, tufa or activated tufa.

12. Filtering device according to claim 1, characterised in that it comprises a plurality of units arranged in parallel.

13. Filtering device according to claim 12, characterised in that some of said units are regenerated in counterflow while the others are working in normal flow condition.
